(19) United States
(12) Patent Application Publication
(10) Pub. No.: US 2012/0140058 A1
(43) Pub. Date: Jun. 7, 2012

(54) STATIC DESALTER SIMULATOR

(76) Inventors: Cato Russell MCDANIEL, The Woodlands, TX (US); Karl KUKLENZ, The Woodlands, TX (US); Kurt GINSEL, Montgomery, TX (US)

(21) Appl. No.: 13/227,665

(22) Filed: Sep. 8, 2011

Related U.S. Application Data
(63) Continuation-in-part of application No. 12/958,656, filed on Dec. 2, 2010.

(51) Int. Cl. B03C 5/02; H04N 7/18

(52) U.S. Cl. 348/86; 204/661; 348/E07.085

(57) ABSTRACT

A static desalter simulator apparatus has a housing for containing a liquid bath and a rack disposed within the housing. The rack is formed of at least two substantially parallel plates separable by a plurality of spacers. An electric field is generatable between the plates, and at least one of the plates includes at least one recess. The apparatus also includes at least one mixing tube for containing an oil-water emulsion, which is positionable within at least one of the recesses. A controller is operatively connected to a mixing tube. An imaging device for generating a digital image or video during a demulsification process is in a mixing tube.

### CROSS-REFERENCE TO RELATED APPLICATIONS

The present application is a continuation-in-part application and claims priority under 35 U.S.C. §120 to U.S. patent application Ser. No. 12/958,656 entitled “Static Desalter Simulator,” filed on Dec. 2, 2010.

### FIELD OF THE INVENTION

The present invention relates generally to the small-scale simulation of crude oil refinery desalters, free water knockouts and heater treaters, and more particularly, to a static desalter simulator that enables the direct observation of the emulsion.

### BACKGROUND OF THE INVENTION

Hydrocarbon feed stocks, such as crude oil, naturally contains a variety of contaminants that have detrimental effects on process equipment and in the operation of a refinery. These contaminants are broadly classified as salts, bottom sediment, water, solids, and metals. The types and amounts of these contaminants vary, depending on the particular hydrocarbon. Additionally, native water present in the liquid hydrocarbon phase as droplets may be coated with naturally occurring surfactants such as asphaltenes, naphthenic acid salts, resins, or with solids including but not limited to iron oxide, silica, carbon, carbonates, or phosphates. Removing the water from the crude oil is essential at crude oil production and processing facilities as it impacts the value of crude oil and its economic transportation. The presence of salts, especially chlorides of Group I and Group II elements of The Periodic Table of Elements, causes corrosion of oil processing equipment. In order to mitigate the effects of corrosion, it is advantageous to reduce the salt concentration to the range of 1 to 5 ppm or less and water content to about 0.10 to 1 wt% by weight of the crude oil prior to transportation and processing of the oil.

A standard treatment for removing small particles of solids and bottom sediment, salts, water and metals is a phase separation operation commonly known as dewatering or desalting. A fresh water wash in the range of typically 4 to 15 vol % is injected into the crude oil. The crude oil and wash water are subjected to shear to thoroughly mix the water and the crude oil to form an emulsion and to transfer the contaminants from the crude oil into the fresh water. Frequently, a chemical emulsion breaker is also added to the emulsion, and often the emulsion is subjected to an electrostatic field so that water droplets in the mixture of crude oil, wash water, and chemical emulsion breaker coalesce in the electrostatic field between electrodes. The coalesced water droplets settle below the oleaginous crude oil phase and are removed. The treated crude oil is removed from the upper part of the separator.

One problem encountered with dewatering and desalting is that some crude oils form an undesirable “rag” layer comprising a stable oil-water emulsion and solids at the water-oil phase boundary in the separator. The rag layer often remains in the vessel but it may be removed for storage or for further processing. Rag layers at the water-oil phase boundary result in oil loss and reduced processing capacity. Heavy crude oils containing high concentrations of asphaltenes, resins, waxes, and napthenic acids exhibit a high propensity to form rag layers.

Additives may be added to improve coalescence and dehydration of the hydrocarbon phase, provide faster water separation, improve salt or solids extraction, and generate oil-free effluent water. These additives, generally known as demulsifiers, are usually fed to the hydrocarbon phase to modify the oil/water interface. It is also possible to feed these materials to the wash water or to both the oil and water. These additives allow droplets of water to coalesce more readily and for the surfaces of solids to be water-wetted. The additives reduce the effective time required for good separation of oil, solids, and water.

Development of new chemical demulsifiers has typically been done using a simple apparatus such as glass bottles or glass tubes and is referred to as “bottle testing”. In the simplest embodiment, oil samples with treatments are added to glass bottles and shaken. The rate of demulsification (water removal) is then monitored as a function of time by observing the amount of “free” water that collects at the bottom of the bottle. These methods have proven to be useful but they often fail to adequately simulate many critical parameters of a desalter and have been of limited use particularly in heavy oils or systems that have a propensity to develop rag layers.

It is desired to improve simulation methods such that one may select the most efficacious chemistries and operating conditions to optimize the emulsion breaker chemistries, oil mixtures, temperatures, emulsion size, and other parameters.

### BRIEF SUMMARY OF THE INVENTION

[INSERT SUMMARY HERE]

Advantages of the present invention will become more apparent to those skilled in the art from the following description of the embodiments of the invention which have been shown and described by way of illustration. As will be realized, the invention is capable of other and different embodiments, and its details are capable of modification in various respects.

### BRIEF SUMMARY OF THE INVENTION

In one aspect of the present invention, a static desalter simulator apparatus is provided. The apparatus includes a housing for containing a liquid bath therein. The apparatus further includes a rack disposed within the housing, and the rack is formed of at least two substantially parallel plates separable by a plurality of spacers. An electric field is generatable between the plates, and at least one of the plates includes at least one recess formed therethrough. The apparatus also includes at least one mixing tube for containing an oil-water emulsion. The at least one mixing tube is positionable within the at least one recess formed in the at least one of said plates. A controller is operatively connected to the at least one mixing tube. An imaging device for generating at least one digital image or digital video during a demulsification process in the at least one mixing tube.

In another aspect of the preset invention, a static desalter simulator apparatus is provided. The apparatus includes a housing for containing a liquid bath therein. A rack is disposed within said housing, and the rack is formed of at least two substantially parallel plates separable by a plurality of spacers. An electric field is generatable between the plates. The apparatus also includes at least one mixing tube for containing an oil-water emulsion, and the at least one mixing tube is supportable by at least one of the plates. The mixing tube includes a measuring container having a connecting portion, a central portion, and a measuring portion. The measuring portion includes a cylindrical tip. The mixing tube also includes a mixing apparatus attachable to the measuring container, wherein at least a portion of the mixing apparatus is positionable within the measuring container. The apparatus further includes a controller operatively connected to the at least one mixing tube.

In yet another aspect of the present invention, a static desalter simulator apparatus is provided. The apparatus includes a housing for containing a liquid bath therein. A rack is disposed within the housing, and the rack is formed of at least two substantially parallel plates separable by a plurality of spacers. An electric field is generatable between the plates. At least one light source is positioned adjacent to the rack, and the at least one light source is configured to provide illumination within the liquid bath. A heater/circulator is operatively connected to the housing for controlling a temperature of the liquid bath and for circulating the liquid bath. The apparatus further includes at least one mixing tube for containing an oil-water demulsification process. The at least one mixing tube is supportable by one of said plates. A controller is operatively connected to the at least one mixing tube. An imaging device is configured to generate at least one digital image or digital video of the demulsification process in the at least one mixing tube. A power source is operatively coupled to at least one of the plates, at least one light source, the heater/circulator, the controller, and the imaging device.

The present invention and its advantages over the prior art will become apparent upon reading the following detailed description and the appended claims with reference to the accompanying drawings.

### BRIEF DESCRIPTION OF SEVERAL VIEWS OF THE DRAWINGS

The above mentioned and other features of this invention will become more apparent and the invention itself will be better understood by reference to the following description of embodiments of the invention taken in conjunction with the accompanying drawings, wherein:

FIG. 1 illustrates a perspective view of a static desalter simulator apparatus according to an embodiment of the invention;

FIG. 2 illustrates a rack used in the static desalter simulator apparatus of FIG. I;

FIG. 3 illustrates a mixing tube used in the static desalter simulator apparatus of FIG. 1;

FIG. 4 illustrates an exploded view of a mixing apparatus attached to the mixing tube of FIG. 3.

### DETAILED DESCRIPTION OF THE INVENTION

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications, and equivalents as will become apparent from consideration of the following detailed description.

A desalter simulator apparatus provides the ability to test emulsion breaker chemistries using different oil mixtures, temperatures, emulsion size, and other parameters. The desalter simulator apparatus uses small amounts of oil to perform the experiments, thereby reducing the cost of oil transport and disposal. In the desalter simulator apparatus, chemical demulsifiers are added to the crude oil and/or wash water, and these are mixed together at a temperature and with a shear and duration approximating that of a mix valve of an industrial desalter to simulate actual field conditions. Then the emulsion is allowed to settle at a temperature and electric field strength and for a residence time approximating that of the desalter.

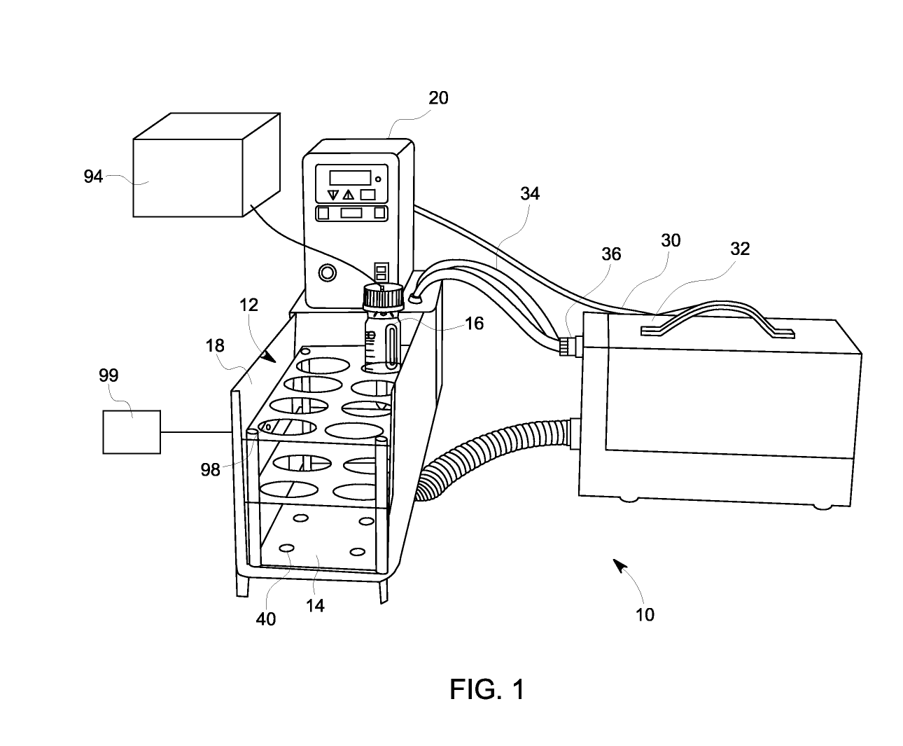

Referring now to FIG. 1, an exemplary static desalter simulator apparatus 10 is shown. The static desalter simulator apparatus 10 contains a liquid bath 12 being defined within a housing 18, and includes a rack 14 disposed therein for receiving a plurality of mixing tubes 16. In an embodiment, the mixing tubes 16 and liquid bath 12 are both transparent materials that allow the operator to visually monitor the demulsification of the samples within the mixing tubes 16 to obtain and record experimental results. The mixing tubes 16 are configured to be at least partially submerged into the liquid bath 12. In an embodiment, only a portion of the mixing tube 16 is submerged into the liquid bath 12. In another embodiment, the entire mixing 16 is submerged into the liquid bath 12.

The static desalter simulator apparatus 10 also contains a power supply 30 located within a suitable power supply box 32, as shown in FIG. 1. In one embodiment, the power supply 30 is a high voltage transformer with a 10 KV AC output. High voltage leads 34 are connected to the power supply 30 with a three-prong plug 36. The power supply 30 is configured to provide electrical power to the rack 14 located within the housing 18.

In an embodiment, a heater/circulator 20 is operatively connected to the liquid bath 12 for circulating the fluid within the liquid bath as well as providing heat to the liquid bath 12, as shown in FIG. 1. The heater/circulator 20 controls the temperature of the liquid bath 12 and permits the emulsion samples to be preheated to a temperature that will best simulate the actual conditions inside an industrial desalter in the field or at a processing facility. The desired temperature of the liquid bath 12 is typically heated to the range of about 200° F. to 300° F. for the a simulation process. At this temperature, the samples within the mixing tubes 16 can also be pressurized to simulate the pressures experienced in an industrial desalter in the field or at a processing facility. Suitable examples of heater/circulators 20 are the Haake DC-3 or DC-30 available from Thermo Fisher Scientific Inc. of Waltham, Mass.

In an embodiment, the heater/circulator 20 is fixed to the wall of the liquid bath 12 and has a pump (not shown) with a swivel-mounted pump nozzle (not shown) to aid in circulation, and therefore, temperature uniformity throughout the liquid bath 12. In an embodiment, the heating fluid circulated within the oil bath is a silicon-based oil. For example, Maxima C Plus vacuum pump oil, available from Thermo Fisher Scientific Inc., can be used as the heating fluid in the liquid bath 12. In another embodiment, water can be used as the heating fluid within the liquid bath 12. It should be understood by one skilled in the art that other fluids may be used as the heating fluid for the liquid bath 12, so long as the fluids allows light to pass therethrough such that the level of water that has coalesced from the emulsion within the mixing tubes 16 can be measured. Ideally, the fluid used in the liquid bath 12 should be inert, or non-reactive with respect to the contents in the mixing tubes 16 in case a mixing tube 16 is damaged and the contents therein escape the mixing tube 16 and mix with the fluid in the liquid bath 12.

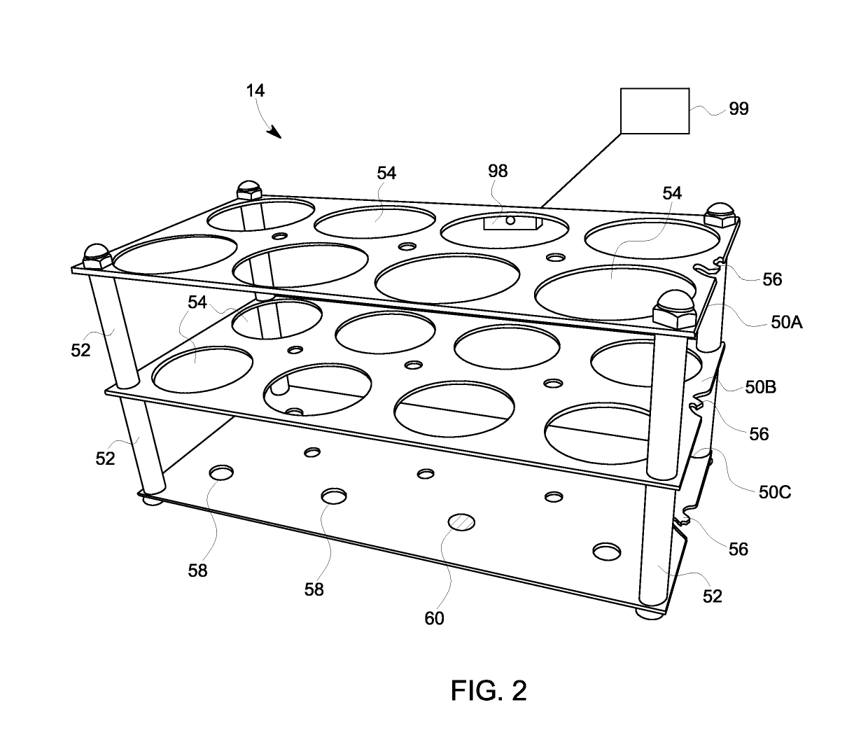

In FIG. 2, one embodiment of the rack 14 for receiving a plurality of mixing tubes 16 is shown. The rack 14 is made of a plurality of substantially parallel plates 50A, 50B, 50C. In an embodiment, the plates 50A, 50B, 50C are substantially the same size and are configured to be located within the housing 18. The plates 50A, 50B, 50C are maintained in a spaced-apart relationship relative to each other by a plurality of spacers 52. The upper pair of plates 50A, 50B has a plurality of recesses 54 formed therein and the recesses 54 of adjacent plates are aligned so as form tubular openings that are sized and shaped to receive the mixing tubes 16 therein in an upright manner. In the illustrated embodiment, the recesses 54 are formed as circular holes or apertures. The recesses 54 may also be formed as square holes, rectangular holes, hexagonal holes, or any other shape that corresponds to the outer surface of the mixing tubes 16 being received therein. It another embodiment, the recesses 54 formed in the upper plate 50A may be a different shape than the recesses 54 formed in the middle plate 50B. It should be understood by one of ordinary skill in the art that the recesses 54 formed in the upper plates 50A, 50B can be of any size or shape that corresponds to the size and shape of a mixing tube 16 receivable therein. In the embodiment illustrated in FIG. 2, the rack 14 is configured to receive eight (8) separate mixing tubes 16. In another embodiment (not shown), the rack 14 is configured to receive four (4) separate mixing tubes 16. It should be understood by one of ordinary skill in the art that the rack 14 can be configured to receive one or more mixing tubes 16 therein. The multiple recesses 54 in the plates 50A, 50B for receiving a plurality of mixing tubes 16 allows testing and evaluation of specific crude oil compositions using different emulsion breaker chemistries, concentrations, and conditions simultaneously. In an embodiment, the lower-most plate 50C includes a plurality of apertures 58 formed therein, wherein the apertures 58 are configured to receive a light source for providing light into the liquid bath 12.

The plates 50A, 50B, 50C have tabs 56 to which electrical leads 34 from the power supply 30 attachable so as to provide an electric field adjacent to the mixing tubes 16 within the liquid bath 12. Although the electric field in a typical production or processing desalter is generated throughout the emulsion therewithin, it has been found that the geometry of the mixing tubes 16 used in the static desalter simulator apparatus 10 is such that an electric field formed within the mixing tubes does not accurately represent the actual electric field generated in an actual production or processing desalter. Accordingly, the electric field in the static desalter simulator apparatus 10 is formed within the liquid bath 12 surrounding the mixing tubes 16. In one embodiment, the middle plate 50B is electrically energized while the top plate 50A and bottom plate 50C are grounded. In an embodiment, the spacers 52 configured to maintain the plates 50A, 50B, 50C in a spaced-apart relationship are formed of an insulating, non-electrically conducting plastic material. For example, the spacers 52 may be formed of Ultem® polyetherimide, available from SABIC Innovative Plastics. It should be understood by one of ordinary skill in the art that the spacers 52 can be fanned of any material sufficient to electrically insulate the plates 50A, 50B, 50C such that the electric field generated between the electrically energized middle plate 50B and the grounded plates 50A, 50C as well as to be mechanically and thermally able to withstand the temperatures and chemicals of the liquid bath 12. Accordingly, two electric fields are generated, one between the middle and upper plates 50B, 50A and another between the middle and lower plates 50B, 50C. The high voltage leads 34 (FIG. 1) connect the power supply 30 to the rack 14 through the housing 18.

The plates 50A, 50B, 50C form an electric grid that generates an electrostatic field at potentials ranging from about 6,000 volts to about 10,000 volts (RMS) to induce dipole attractive forces between neighboring droplets, which causes them to migrate towards each other and coalesce. Once emulsions of suitable drop size distribution are prepared, the samples are exposed to the electric field. The electrostatic field causes each droplet to have a positive charge on one side and a negative charge on the other. The droplets coalesce because of the attractive force generated by the opposite charges on neighboring droplets. The attractive force is strongly affected by the distance between the droplets and is much stronger when the droplets are in close proximity. Various geometries can be used to accommodate various pluralities of tubes. In one embodiment, up to eight mixing tubes 16 can be run at a time.

In an embodiment, the static desalter simulator apparatus 10 also contains at least one light source 40 located within or below the housing 18 to provide illumination through the liquid bath 12 to the mixing tubes 16 to aid in observation of the demulsification process within the mixing tubes 16. The light source 40 is positioned adjacent to the rack 14 and may either be operatively connected to the rack 14 or positioned in a spaced-apart manner relative to the rack 14. In one embodiment, the light source is a fiber optic light source extending from the power supply 32 that connects to an under light positioned within aperture 58 formed in the lower plate 50C within the liquid bath 12. In another embodiment, as shown in FIG. 1, the light source 40 includes a plurality of light emitting diodes (LEDs) 60 (FIG. 2) disposable within the recesses 74 formed in the lower plate 50C below the liquid bath 12. Whereas the fiber optic light source requires a hot light source—such as a bulb or halogen light—to generate the illumination, the LEDs 60 provide a cool light source that does not generate a significant amount of heat. This is particularly desirable for use in the static desalter simulator apparatus 10 because of the fire and explosion potentials of liquid(s) used in the liquid bath 12, the crude oil samples within the mixing tubes 16, or the breaker chemicals added to the crude oil samples also within the mixing tubes 16. Also, the lifetime of LEDs 60 between when they need to be replaced is much longer relative to the short lifetime of hot light sources such as light bulbs or halogen lights previously used in the art. Another advantage provided by an LED light source is that a particular or specific wavelength of light emitted therefrom can be pre-determined. As such, the ability to choose a particular wavelength will make it possible to provide a better color or light differential at the interface between the oil emulsion and the water that has demulsified within the mixing tubes 16, thereby provide for more accurate readings during operation of the static desalter simulator apparatus 10. The light source 40 may produce light in the visible, near IR, and/or UV spectrums and can be of any design known to those skilled in the art. When LEDs 60 are used in the near IR spectrum, the water absorbs the light and the oil does not, thereby providing a reverse color output than in the visible spectrum. It should be understood by one of ordinary skill in the art that LEDs are provided as an exemplary embodiment of a light source, but any other type of light source can be used to produce a pre-determined spectrum or range of light. The transparent liquid bath 12 permits observation of the effects that changing emulsion breaker chemistries, operating conditions, oil mixtures, temperatures, emulsion size, and other parameters have on the process.

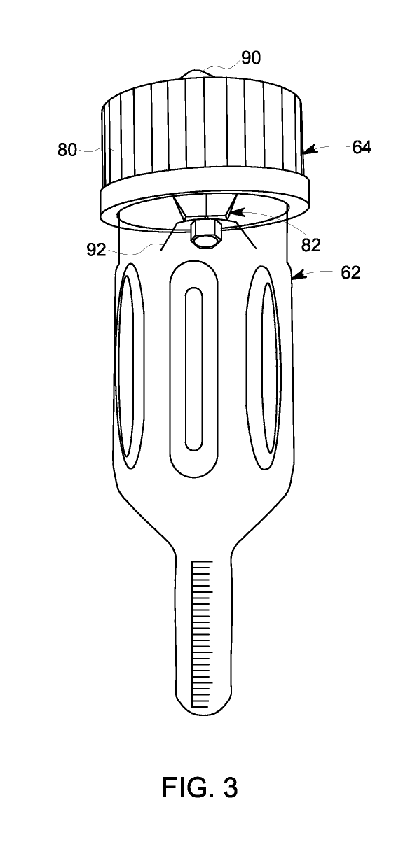

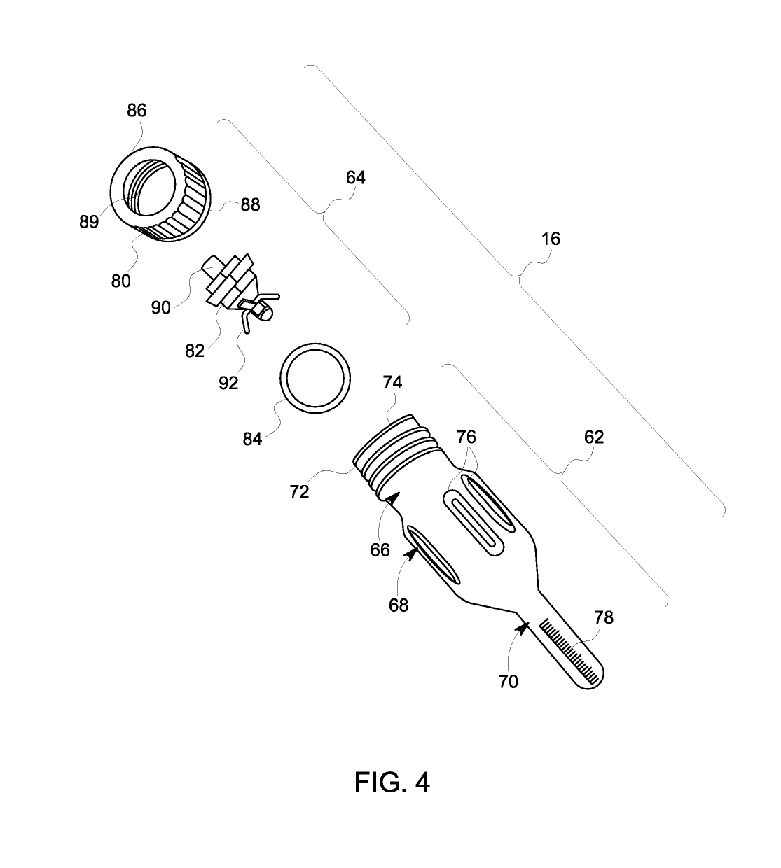

FIGS. 3-4 illustrates an exemplary embodiment of a mixing tube 16 used in the static desalter simulator apparatus 10. In an embodiment, the mixing tube 16 includes a measuring container 62 and a mixing apparatus 64. The mixing apparatus 64 is removably attachable to the measuring container. The measuring container 62 has a connecting portion 66, a central portion 68, and a measuring portion 70. The connecting portion 66 is configured to receive the mixing apparatus 64. In an embodiment, the connecting portion 66 includes threads 72 for providing a threaded engagement with the mixing apparatus 64. Other latching mechanisms for connecting the mixing apparatus 64 and the connecting portion 66 may include a latch, a key-and-groove, or the like. It should be understood by one of ordinary skill in the art that any other connecting or latching mechanism may be used to operatively connect the mixing apparatus 64 to the connecting portion 66 of the measuring container 62. The connecting portion 66 also includes an opening 74 through which a portion of the mixing apparatus 64 is insertable when attached to the measuring container 62. In an embodiment, the connecting portion 66 is generally cylindrical. In an embodiment, the diameter of the connecting portion 66 is substantially the same as the diameter of the central portion 68. In another embodiment, as shown in FIG. 3, the diameter of the connecting portion 66 is smaller than the diameter of the central portion 68 such that a shoulder provides a transition between the different diameters of adjacent portions of the measuring container 62. Although the measuring container 62 is illustrated as having a generally circular cross-sectional shape along the axial length thereof, it should be understood by one of ordinary skill in the art that the cross-sectional shape of any portion of the measuring container 62 may be non-circular, and it should also be understood by one of ordinary skill in the art that the cross-sectional shape of the measuring container 62 need not be the same along the entire axial length thereof.

In an exemplary embodiment, the central portion 68 of the measuring container 62 includes a plurality of Morton indentations 76 formed therein, as illustrated in FIGS. 3-4. The Morton indentations 76 are elongated indentations extending radially inward from the outer surface of the measuring container 62. The Morton indentations 76 promote the agitation of the oil and water mixture within the measuring container 62 when the mixing apparatus 64 is activated. The central portion 68 is formed as a generally elongated cylindrical portion having a substantially circular cross-sectional shape. It should be understood by one of ordinary skill that the central portion 68 may be formed of any cross-sectional shape. The connecting portion 66 extends from one end of the central portion 68, and the measuring portion 70 extends from the opposing end of the central portion 68.

In an embodiment, the measuring portion 70 of the measuring container 62 is an elongated member configured to receive a portion of the crude oil/water emulsion sample and into which the coalesced water tends to accumulate. In an embodiment, the measuring portion 70 is formed as a cylindrical tip, as shown in FIGS. 3-4, wherein the measuring portion 70 forms an elongated, substantially cylindrical member having a rounded end. In an embodiment, the measuring portion 70 is configured to provide a measurement for about 2-20 milliliters of fluid volume. In another embodiment, the measuring portion 70 is configured to contain and provide a measurement for about eight milliliters (8.0 mL). However, it should be understood by one of ordinary skill in the art that the measuring portion 70 can be configured to provide a measurement for any amount of volume sufficient to adequately and accurately evaluate the efficiency of the breaker chemistries and conditions of a demulsification process within the mixing tube 16. Because oil and water typically separate, and the oil stays afloat atop the water, as the water droplets of the emulsion coalesce and form larger water droplets the coalesced water collects within the measuring portion 70 of the measuring container 62. The amount of water collected, or demulsified from the oil-water emulsion, in the measuring portion 70 is measured using a plurality of marks 78 that indicate a pre-determined volume of liquid for each successive mark. In an embodiment, each mark 78 indicates one-tenth of a milliliter (0.10 ml). In another embodiment, each mark 78 indicates two-tenths of a milliliter (0.20 ml). In other embodiments, each mark 78 may indicate a volume between about one-tenth of a milliliter to about one centiliter (0.10 ml-1 cl), depending on the size of the measuring container 62 and the amount of fluid therewithin. It should be understood by one of ordinary skill in the art that the marks 78 may be configured to measure any portion of fluid, but it should also be understood by one of ordinary skill in the art that it is preferable that all marks are spaced apart in a manner to accurately measure the same fluid volume between each mark. In an embodiment, the marks 78 are etched into the outer surface of the measuring portion 70. In another embodiment, the marks 78 are painted, screen printed, or otherwise affixed to the outer surface of the measuring portion 70.

In an embodiment, the measuring container 62 is formed of glass. In another embodiment, the measuring container 62 is formed of clear plastic. It should be understood by one of ordinary skill in the art that the measuring container 62 can be formed of any transparent material that allows for heat transfer between the liquid bath 12 and the fluid disposed within the measuring container 62 while being inert or non-reactive with the fluid of the liquid bath 12 as well as with the oil, water, and chemicals used to form the emulsion within the measuring container 62. Each measuring container 62 is of sufficient thickness to not break under normal usage in the static desalter simulator apparatus 10. In an exemplary embodiment, the measuring container 62 is formed of glass having a thickness of about three and a half millimeters (3.5 mm). The volume defined within the measuring container 62 can vary but the size and shape of the outer surface thereof should generally correspond to the size and shape of the corresponding recesses in the upper and middle plates 50A, 50B of the rack 14.

During actual processing of crude oil, the containers that receive the oil-water mixture and in which the emulsion is formed are large enough that the inner walls of the container that contact the emulsion do not provide a significant amount of contact with the emulsion to significantly aide in the coalescence of water within the emulsion. Accordingly, to accurately model the conditions of an actual demulsification on a smaller scale with the static desalter simulator apparatus 10, the inner surface of the measuring container 62 of the mixing tube 16 of one embodiment is covered with a coating. In an embodiment, the inner surface of the mixing tube 16 is coated, or “capped,” to generate a substantially hydrophobic inner surface of the measuring container 62. In another embodiment, the inner surface of the mixing tube 16 is coated to produce a hydrophilic surface. The coating is chemically bonded to the inner surface of the mixing tube 16. The hydrophobic layer can be produced using hexadecyl or phenyl silane that effectively prevents water from coalescing with the help of the surface of the measuring container 62. The hydrophobic coating “caps” the active sites of the measuring container material such that the inner surface does not actively assist in the coalescence of water molecules, better simulating the actual conditions during processing in the field. It should be understood by one of ordinary skill in the art that the inner surface of the measuring container 62 can also be coated such that the inner surface is hydrophilic or have any other type of coating to allow the static desalter simulator apparatus to more accurately represent the in-field processing conditions.

As illustrated in FIGS. 3-4, an embodiment of the mixing tube 16 of the static desalter simulator apparatus 10 contains mixing apparatus 64. In one embodiment, the mixing apparatus 64 is an electrically variable stirring device. The mixing apparatus 64 includes a cap 80, a rotatable blade assembly 82, and a sealing ring 84. In an embodiment, the cap 80 is formed as a substantially cylindrical member having an opening at each opposing ends thereof. The opening formed through the first end 86 of the cap 80 is configured to be directed away from the measuring container 62. The second end 88 is configured to receive the connecting portion 66 of the measuring container 62, and the opening formed through the first end 86 of the cap 80 is configured to allow a portion of the blade assembly 82 to extend therethrough. In an embodiment, the cap 80 includes threads 89 that correspond to the threads 72 formed on the connecting portion 66 of the measuring container 62 to provide a threaded connection between the mixing apparatus 64 and the measuring container 62.

In an embodiment, the rotatable blade assembly 82 of the mixing apparatus 64 is formed as a circular disc having an outer diameter that corresponds to the inner diameter of the cap 80 as well as the outer diameter of the opening 74 of the measuring container 62. Because the blade assembly 82 is configured to be located between the measuring container 62 and the cap 80, one of ordinary skill in the art would understand that the size and shape of the blade assembly 82 should correspond to both the cap 80 as well as the measuring container 62 so as to provide a tight seal therebetween to prevent the emulsion within the measuring container 62 to be released during testing of the sample. In an embodiment, a sealing ring 84 is positioned between the blade assembly 82 and the measuring container 62 to ensure a proper seal therebetween.

In the embodiment illustrated in FIGS. 3-4, the blade assembly 82 includes a shaft 90 operatively connected to a rotatable blade 92. The shaft 90 is oriented in a substantially manner along the longitudinal axis of the measuring container 62. The first distal end of the shaft 90 includes a shaped recess (not shown), and the shaped recess is configured to receive an adapter that causes the shaft 90 to rotate about its axis when the controller 94 (FIG. 1) is activated. The shaft 90 is directly connected to the blade 92 such that rotation of the shaft 90 causes the blade 92 to rotate about the axis thereof. The blade assembly 82 is configured to be attached the measuring container 62 such that at least a portion of the blade assembly 82 extends into the measuring container 62. The blade 92 includes multiple fins or tines that are configured to rotate about the shaft 90, thereby mixing the oil-water mixture to create an emulsion within the mixing tube 16. A variety of mixer blade designs and shaft lengths can be used inside the mixing tubes 16. Typically, a 4-fin stainless steel paddle blade 68 is used. However, it should be understood by one of ordinary skill in the art that the blade 92 may include any number of fins.

Assembly of the mixing tube 16 is performed by locating a sealing ring 84 between the opening 74 of the measuring container 62 and the blade assembly 82 of the mixing apparatus 64. The cap 80 is then disposed over the blade assembly 82 such that the threads 88 of the cap 80 mesh with the corresponding threads 72 of the measuring container 62 to provide a seal therebetween. The first distal end of the shaft 90 of the blade assembly 82 extends outwardly beyond the cap 80 for connection to a driving mechanism configured to rotate the shaft 90 and blade 92.

In the embodiment illustrated in FIG. 1, the static desalter simulator apparatus 10 further includes a controller 94 disposed adjacent to the housing 18. The controller 94 includes a driving motor, and the controller 94 is operatively connected to the mixing apparatus 64 of the mixing tube 16. The driving motor of the controller 94 is operatively connected to the shaft 90 of the mixing apparatus 64 to drive the shaft 90 in a rotating manner. The driving motor of the controller 94 can drive the shaft 90 at a constant rotational velocity or vary the rotational velocity thereof. In an embodiment, mixing speed is, optionally, controlled using a variable transformer operatively connected to the driving motor within the controller 94. The duration of mixing is optionally controlled by any conventional electronic device timer suitable for precision timing of the on/off switching of an electrical appliance. In an embodiment, a timer is integrated with the driving motor of the controller 94 so as to activate the driving motor for a pre-determined amount of time. In another embodiment, a timer is operatively connected to the driving motor such that the timer is user-actuated so that the user can activate the driving motor for a pre-determined amount of time or user-actuated so that the user can actively determine the activation timing of the driving motor on a real-time basis using a switch, lever, or other means for actuating the timer. The operator can select the rotational velocity or stirring rate of the mixing apparatus 64 to vary the shearing energy used to make the emulsion. Suitable timers are available from GraLab of Centerville, OH. In one embodiment, the mixing apparatus 64 includes rotational speed settings that can be set at 4,000, 7,000, 10,000, 13,000, and 16,000 RPM by the driving motor. It has been found that in a 100 ml mixing tube 16, the relation of the each 1,000 rpm/2 sec=1 psi of the mix valve of a desalter.

In operation, the crude oil residence time within the mixing tube 16 is typically between about 15 and 30 minutes. This corresponds to typical residence times for desalters treating crude oil with API gravities from 15 to 28.

In an embodiment of the static desalter simulator apparatus 10, an imaging device 98 is operatively connected to a processor 99, as shown in FIG. 1. The imaging device 98 can be a digital photo camera, a digital video recorder, or any other means for providing a permanent digital image of the mixing tube 16 for use in recording the demulsification process. The processor 99 is configured to selectively control the operation of the imaging device 98 as well are receive the digital image(s) or video(s) produced by the imaging device 98. Through the selective control of the imaging device 98, the processor 99 is capable of determining the timing and/or frequency that the imaging device 98 produces a digital image to be received by the processor 99. In an embodiment, the imaging device 98 can be located outside, or external to the liquid bath 12 such that the imaging device 98 produces a digital image through a window (not shown) located in the housing 18 and through the liquid bath 12. In another embodiment, the imaging device 98 is located within the liquid bath 12 at a position adjacent to the mixing tube 16.

In an embodiment, the imaging device 98 is operatively connected to the housing 18, as shown in FIG. 1. In another embodiment, the imaging device 98 is operatively connected to the rack 14 within the liquid bath 12. It should be understood by one of ordinary skill in the art that the imaging device can be positioned at any location that allows the imaging device 98 to selectively or continually provide a digital image of the mixing tube(s) 16 located within the liquid bath 12. The imaging device 98 can be operated manually or by using a processor 99 to record digital images at desired time intervals such that the operator need not be present. The imaging device 98 allows for the analysis of a still digital image or video to determine the volume of water that has separated from the sample emulsion either manually by a user or by the processor 99. In an embodiment, the image produced by the imaging device 98 is analyzed by a user to determine the volume of demulsified water using the marks 78 on the measuring portion 70 relative to the amount of time that has lapsed. In another embodiment, the processor 99 includes software designed to perform an analysis of the digital image produced by the imaging device 98, wherein the software is capable of determining the volume of demulsified water according to the measurement marks 78 on the measuring portion 70 relative to the amount of time that has lapsed. This data or values of demulsified volume and time is generated by the processor 99 and is then used to generate a plot that represents a correlation between the demulsification rate in the simulator and the actual demulsification rate in crude oil production and processing facilities to predict or determine the most ideal chemistries for use in the demulsification process.

The invention is also directed to a method of using the desalter simulator to select demulsifiers for refinery crude oil desalters. In one embodiment, the same oil/water ratio as found in the desalter system to be modeled is used, and the amount of water, which separates out of the emulsion as a function of time, is recorded and averaged. The treatment with the highest mean water drop and least residual emulsion is selected. In addition, in some cases, the reverse of the desalter system's oil/water ratio is used, and the clarity of the water as a function of time is recorded. The treatment with the fastest and most complete oil rise is selected.

In performing tests with raw crude, the crude should be mixed well by a shaker for at least 15 minutes. If a low shear sampler (LSS) is available, the crude should be poured into the LSS and stirred at the minimum setting, which will vortex the whole sample for at least 15 minutes. The crude is then transferred into the mixing tubes 16 while dispensing. Tests are performed such that the BS&W, specific gravity of the crude, and pH of the wash water are measured. (BS&W is an abbreviation for Basic or Bottom Sediment & Water. It is a measure of the non-asphaltic solids and water (often mostly water) present in a hydrocarbon sample.) The process temperature, the ratio of wash water, the mix valve pressure and setting of the electrical field are also recorded.

In operation, at least one measuring container 62 is filled with a pre-determined sample mixture of crude oil, water, and breaking chemicals configured to assist or enhance the demulsification of the water from the sample. The mixing apparatus 64 is then attached to the end of the measuring container 62. Once at least one mixing tube 16 has been assembled, each of the mixing tubes 16 containing a sample to be analyzed is positioned within the recesses formed in the upper pair of plates 50A, 50B of the rack 14 within the housing 18. The heater/circulator 20 is then activated to heat the fluid within the liquid bath 12 to a desired temperature for a period of time to ensure the sample within each mixing tube 16 is likewise heated to the desired temperature. Once the sample within each mixing tube 16 has been heated to the desired temperature, the mixing tubes 16 are inverted and the controller 94 is activated to cause the blade 92 of the mixing apparatus 64 to rotate for a pre-determined time to produce an emulsion within the measuring container 62. In another embodiment, there is no need to invert the mixing tubes 16 as the mixing apparatus 64 is configured to generate the emulsion as the mixing tubes 16 remain positioned in the rack 14. The emulsion for each mixing tube 16 can be generated using a different speed of the blade 92 and/or length of time that the mixing apparatus 64 is operated. Once the emulsions within the mixing tubes 16 are generated, the imaging device 98 begins to record images or videos of each mixing tube 16. The images produced by the imaging device 98 are transferred to the processor 99 for processing. In the end, a demulsification rate for each of the mixing tubes 16 is generated.

### EXAMPLE

In order to assess the emulsion-breaking efficacy of the candidate materials, simulated desalter tests were undertaken using the static desalter simulator apparatus 10. The static desalter simulator apparatus 10 comprises the liquid bath 12 reservoir provided with a plurality of mixing tubes 16 dispersed therein. The temperature of the liquid bath 12 can be varied to about 250° F. to simulate actual field conditions. The mixing tubes 16 are placed into the rack 14 and the electrical field is activated to impart an electrical potential through the test emulsions.

The conditions of the process were:

Process Temperature: 250° F.

Water Ratio: 5%

Mix valve pressure: 10 psi

Grids on

Pre-heat the liquid bath 12 to 250° F.

The blade 92 of the mixing apparatus 64 was set to 10,000 rpm, and the timer for 2 seconds

5 ml of the wash water was added to the tube

95 ml of the crude was added to the tube. Treat the tube with oil-based chemical to oil phase.

The mixing tube 16 was capped and placed into the pre-heated liquid bath for 30 minutes.

The electrical field was turned on, and the tubes were emulsified (10,000 rpm/2 sec=10 psi).

The water drop in each tube was recorded after 1, 2, 4, 8, 16, 32 minutes. The interface, and the clarity of the water layer were also recorded. The mean water drop (Mean WD) was calculated. The product having the largest mean WD is typically the most desirable product.

Accordingly, the static desalter simulator apparatus 10 permits the operator to simulate useful parameters including but not limited to: desalter vessel temperatures, residence time and electric fields. The emulsion is resolved in the mixing tubes 16 with the assistance of the emulsion breaking chemicals and may also be assisted by the known method of providing an electrical field to polarize the water droplets. Once the emulsion is broken, the water and petroleum media form distinct phases. A water phase is separated from a petroleum phase and subsequently monitored in the measuring portion of the mixing tube.

While the disclosure has been illustrated and described in typical embodiments, it is not intended to be limited to the details shown, since various modifications and substitutions can be made without departing in any way from the spirit of the present disclosure. As such, further modifications and equivalents of the disclosure herein disclosed may occur to persons skilled in the art using no more than routine experimentation, and all such modifications and equivalents are believed to be within the scope of the disclosure as defined by the following claims.

1. A static desalter simulator apparatus comprising:
a housing for containing a liquid bath therein;
a rack disposed within said housing, said rack formed of at least two substantially parallel plates separable by a plurality of spacers, an electric field being generatable between said plates, and wherein at least one of said plates includes at least one recess formed therethrough;
at least one mixing tube for containing an oil-water emulsion, wherein each mixing tube includes an inner surface, and said at least one mixing tube is positionable within said at least one recess formed in said at least one of said plates;
a controller operatively connected to said at least one mixing tube; and
an imaging device for generating at least one digital image or digital video during a demulsification process in said at least one mixing tube.

2. The static desalter simulator apparatus of claim 1 further comprising a light source located within or below said housing for providing illumination through said liquid bath.

3. The static desalter simulator apparatus of claim 2, wherein said light source includes at least one light emitting diode (LED).

4. The static desalter simulator apparatus of claim 1, wherein said at least one mixing tube comprises:
a measuring container and a mixing apparatus attached to said measuring container, wherein said measuring container includes a measuring portion having a cylindrical tip.

5. The static desalter simulator apparatus of claim 1, wherein said at least one mixing tube comprises:
a measuring container and a mixing apparatus attached to said measuring container, wherein said mixing apparatus includes a cap and blade assembly, at least a portion of said blade assembly being disposed within said measuring container and secured thereto by said cap.

6. The static desalter simulator apparatus of claim 1, wherein said inner surface of at least one mixing tube is covered by a coating.

7. The static desalter simulator apparatus of claim 6, wherein said coating is chemically bonded to said inner surface.

8. The static desalter simulator apparatus of claim 7, wherein said coating covering said inner surface of at least one mixing tube is hydrophobic.

9. The static desalter simulator apparatus of claim 7, wherein said coating covering said inner surface of at least one mixing tube is hydrophilic.

10. The static desalter simulator apparatus of claim 1, wherein said imaging device is a digital photo camera or a digital video camera.

11. The static desalter simulator apparatus of claim 1 further comprising a processor operatively connected to said imaging device, wherein said digital image or digital video generated by said imaging device is received by said processor.

12. The static desalter simulator apparatus of claim 11, wherein said processor selectively controls said imaging device.

13. The static desalter simulator apparatus of claim 11, wherein said processor analyzes said at least one digital image or digital video to generate a demulsification rate.

14. A static desalter simulator apparatus comprising:
a housing for containing a liquid bath therein;
a rack disposed within said housing, said rack formed of at least two substantially parallel plates separable by a plurality of spacers, an electric field being generatable between said plates;
at least one mixing tube for containing an oil-water emulsion, said at least one mixing tube supportable by at least one of said plates, said at least one mixing tube comprising:
a measuring container having a connecting portion, a central portion, and a measuring portion, wherein said measuring portion includes a cylindrical tip with a rounded end; and
a mixing apparatus attachable to said measuring container, wherein at least a portion of said mixing apparatus is positionable within said measuring container; and
a controller operatively connected to said at least one mixing tube.

15. The static desalter simulator apparatus of claim 14, wherein said central portion of said measuring container includes a plurality of Morton indentations formed therein.

16. The static desalter simulator apparatus of claim 14 further comprising a plurality of marks located on said measuring portion for measuring a volume of demulsified water.

17. The static desalter simulator apparatus of claim 14, wherein an inner surface of said measuring container has a coating thereon.

18. The static desalter simulator apparatus of claim 17, wherein said coating is hydrophobic.

19. The static desalter simulator apparatus of claim 18, wherein said hydrophobic coating is formed using hexadecyl or phenyl silane.

20. A static desalter simulator apparatus comprising:
a housing for containing a liquid bath therein;
a rack disposed within said housing, said rack formed of at least two substantially parallel plates separable by a plurality of spacers, an electric field being generatable between said plates;
at least one light source positioned adjacent to said rack, said at least one light source configured to provide illumination within said liquid bath;
a heater/circulator operatively connected to said housing for controlling a temperature of said liquid bath and for circulating said liquid bath;
at least one mixing tube for containing an oil-water demulsification process, said at least one mixing tube supportable by one of said plates;
a controller operatively connected to said at least one mixing tube; and
an imaging device for generating at least one digital image or digital video of said demulsification process in said at least one mixing tube; and
a power source operatively coupled to at least one of said plates, said at least one light source, said heater/circulator, said controller, and said imaging device.

21. The static desalter simulator apparatus of claim 20 further comprising a processor operatively connected to said imaging device for selectively activating said imaging device.
